(19) United States
(12) Patent Application Publication
(10) Pub. No.: US 2017/0035003 A1
(43) Pub. Date: Feb. 9, 2017

(54) COLLAPSIBLE SHELTER FOR TREES, SHRUBS AND VINES

(71) Applicant: AVINTIV Specialty Materials Inc., Charlotte, NC (US)

(72) Inventor: Paul Stuart Wormald, Maldon Essex (GB)

(21) Appl. No.: 15/228,563

(22) Filed: Aug. 4, 2016

Related U.S. Application Data
(60) Provisional application No. 62/201,443, filed on Aug. 5, 2015.

(51) Int. Cl. A01G 13/02; A01G 13/10

(52) U.S. Cl. CPC A01G 13/0243; A01G 13/10

(57) ABSTRACT

Collapsible shelters for trees, shrubs and vines are provided. The collapsible shelters may be configured to be collapsible in the axial or the longitudinal direction. The collapsible shelters can be transported to a site of use in a collapsed configuration and expanded into an uncollapsed configuration at the site of use.

### PRIORITY CLAIM

This application claims priority under 35 U.S.C. §119(e) to U.S. Provisional Application Ser. No. 62/201,443, filed on Aug. 5, 2015, which is expressly incorporated by reference herein in its entirety.

### TECHNICAL FIELD

The invention relates generally to a shelter to protect and enhance the growth of young plants. In particular, the invention relates to a collapsible shelter that can be readily transported to the site for use.

### BACKGROUND

Tree and plant shelters may typically comprise a basic plastic structure configured to surround the tree or the plant to allow the tree or plant to grow without being disturbed by harsh environmental elements or become disturbed by animals. The plastic used may be translucent to allow some light to reach the growing tree or plant through the walls of the basic plastic structure. Other configurations merely allow light to pass through one or more openings in the structure.

The opaque nature of conventional plastic structures typically does not allow a sufficient amount of light to reach the tree or the plant through the walls of the structure. While one or more additional openings may be configured into the structure, these openings may allow either the growth or survival of the tree or plant to be compromised due to contact with environmental elements or animals. Smaller apertures may be provided to mitigate unwanted exposure to environmental elements and/or animals, however, the tree or plant may still suffer wind damage. Additionally, the apertures or other openings provided in the structure may compromise the overall strength of the structure as well. Apertures and/or openings also provide growth avenues for the tree or plant, and when it is time for the shelter to be removed, damage may occur to those portions of the tree or plant that extend though such apertures or openings.

Conventionally formed structures also tend to be bulky and consume quite a large volume. This increases the cost of transportation to the installation site per unit volume. Form fitted structures that may be stacked one on top of the other do not necessarily provide the shape conducive to protecting the tree or plant and perhaps may also compromise the growth of the tree or plant that the structure surrounds. Structures may be provided that are either unassembled that require assembly at the installation site, but this requires additional time to install the structure. Other options may be to provide structures that otherwise are collapsed and then are expanded at the site. However, because the structures typically must be pushed into the ground, structures configured to collapse tend not to be as resilient to the force that must be applied to secure the structure into the ground. These structures also can tend to not be as resilient to the elements of nature such as wind and heavy rain.

There at least remains a need in the art for a robust and resilient tree or plant shelter that protects young plants or saplings from the elements of nature while still providing sufficient light to facilitate growth in the tree or plant. There also remains a need in the art for a tree or plant shelter that assumes a smaller volume profile for efficient transport to the site where the shelter is to be installed yet allowing the shelter to become easily and fully extended for installation at the site.

### SUMMARY OF INVENTION

One or more embodiments of the invention may address one or more of the aforementioned problems. Certain embodiments, according to the invention, provide a shelter for protecting and enhancing the growth of plants, in particular, young trees, shrubs, and/or vines. Certain embodiments of the invention are directed to a collapsible shelter that may be more readily transported to the site of use while economizing on required shipping and carrying volume.

In accordance with certain embodiments of the invention, collapsible shelters are provided, in which the collapsible shelter may be provided in a collapsed configuration (e.g., such as for storage and/or transportation) or uncollapsed configuration (e.g., generally open structure defining a conduit through which a plant or tree can pass). In accordance with certain embodiments of the invention, the collapsible shelter may be configured to transition back and forth between a collapsed configuration and an uncollapsed configuration, such that a single collapsible shelter may be reused one or more times. An embodiment of the invention provides a shelter comprising a longitudinal tubular structure having (i) a first end and a second end being diametrically opposed to the first end; (ii) a first compression side extending longitudinally from the first end to the second end; (iii) a second compression side diametrically opposed to the first compression side; (iv) a first of the longitudinal structure defined by the first compression side, the second compression side, the first end and the second end; and (v) a second side of the longitudinal structure opposed to the first side. Further pursuant to this embodiment of the invention, the first compression side and the second compression side may be configured to flexibly pivot inwardly allowing the first side to become substantially parallel to the second side. According to another embodiment of the invention, when the first side is substantially parallel to the second side, the second side is configured to bow flexibly inward to allow the second side to become substantially aligned with the first side.

In an embodiment of the invention, the first compression side and the second compression side may be defined by any one of or any combination of a stretchable region, a crease extending from the first end to second end in a body of the longitudinal tubular structure, a fluted structure extending from the first end to second end in a body of the longitudinal tubular structure, a dimpled structure extending from the first end to second end in a body of the longitudinal tubular structure, and a hinged structure extending from the first end to second end in a body of the longitudinal tubular structure.

In one aspect, the invention provides a shelter comprising a longitudinal tubular structure having (i) a first end and a second end being diametrically opposed to the first end; (ii) a first support ring circumferentially surrounding the longitudinal tubular structure at the first end; and (iii) a second support ring circumferentially surrounding the longitudinal tubular structure at the second end, in which the longitudinal tubular structure is configured to collapse in the longitudinal direction upon application of an external force in the longitudinal direction.

In an embodiment of the invention, the first support ring may additionally comprise a cover member configured to substantially surround the longitudinal tubular structure when the longitudinal tubular structure is collapsed into a substantially complete collapsed state. In accordance with certain embodiments of the invention, the longitudinal tubular structure configured to collapse in the longitudinal direction may be fluted. According to another example embodiment of the invention, the longitudinal tubular structure configured to collapse in the longitudinal direction may comprise a spring. In yet other embodiments of the invention, the longitudinal tubular structure configured to collapse in the longitudinal direction may be fluted and comprise a spring.

In an embodiment of the invention, the spring may spiral and surround the outside (e.g., an external surface) of the longitudinal tubular structure and/or the inside (e.g., an internal surface) of the longitudinal tubular structure. In accordance with certain embodiments of the invention, the spring may be disposed or located internal (e.g., within the body or wall of the longitudinal tubular structure) to the longitudinal tubular structure. The spring may comprise a compression spring or a tension spring.

The shelter may also comprise at least one other longitudinal structure (e.g., a second longitudinal tubular structure, a third longitudinal structure, etc.). For example, one of these at least other longitudinal structure (e.g., a second longitudinal tubular structure) may be defined by a third end and a fourth end diametrically opposed to the third end. The third end may connect to the second end by sharing the second support ring located between the two longitudinal tubular structures). These additional longitudinal support structures may further comprise a support ring, for example, at the opposite end.

In another aspect, the invention provides methods of protecting a plant or tree is provided. According to an embodiment of the invention, the method for protecting a plant or tree may comprise placing a collapsible shelter as disclosed herein around a plant or tree. In accordance with certain embodiments of the invention, the length of the collapsible shelter may be expanded or increased in one or more increments as the plant or tree grows over a period of time.

Another aspect of the invention provides a method for manufacturing a collapsible shelter. In accordance with certain embodiments, a method for manufacturing a collapsible shelter may comprise the steps of forming a longitudinal tubular structure defined by a first end, a second end diametrically opposed to the first end, a first longitudinal compression side or line, and an oppositely configured second longitudinal compression side or line. Alternatively, the first longitudinal compression side or line and oppositely configured second longitudinal compression side or line may be formed into the longitudinal tubular structure in certain embodiments of the invention.

According to another embodiment of the invention, a method for manufacturing a collapsible shelter includes the steps of forming one or more longitudinal tubular structures, whereby such structures may be fluted and/or include a spring member to allow the longitudinal tubular structures to be collapsed; and providing rings to define the openings of the longitudinal tubular structure or interconnect the more than one longitudinal tubular structure. According to certain embodiments of the invention, the rings may be further configured to cover the one or more longitudinal support members when in the collapsed position.

Still other objects and features will become apparent from the following detailed description considered in conjunction with the accompanying drawings.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

FIG. 1A is an isometric view of a collapsed shelter according to an embodiment of the invention;

FIG. 1B is an isometric view of the shelter of FIG. 1A in an expanded configuration according to an embodiment of the invention;

FIG. 1C is a cross-sectional view of a collapsed shelter according to another embodiment of the invention;

FIG. 2A is an isometric view of a collapsed shelter according to another embodiment of the invention;

FIG. 2B is an isometric view of the shelter of FIG. 2A in an expanded configuration according to another embodiment of the invention;

FIG. 3A is an isometric view of a collapsed shelter according to another embodiment of the invention;

FIG. 3B is an isometric view of the shelter of FIG. 3A in an expanded configuration according to another embodiment of the invention;

FIG. 4A is an isometric view of a collapsed shelter according to another embodiment of the invention;

FIG. 4B is an isometric view of the shelter of FIG. 4A in an expanded configuration according to another embodiment of the invention;

FIG. 5A is an isometric view of a collapsed shelter according to another embodiment of the invention; and

FIG. 5B is an isometric view of the shelter of FIG. 5A in an expanded configuration according to another embodiment of the invention.

### DETAILED DESCRIPTION

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

It is to be understood, however, that the drawings are designed solely for purposes of illustration and not as a definition of the limits of the invention, for which reference should be made to the appended claims. Any relative dimensions illustrated in the figures are given by way of example and are not intended to be limiting. As would be appreciated by a person having ordinary skill in the art, the relative dimensions can vary depending on any number of factors including, without limitation, the intended use and performance of the illustrated article.

The terms “substantial” or “substantially” may encompass the whole amount as specified, according to certain embodiments of the invention, or largely but not the whole amount specified according to other embodiments of the invention.

The terms “polymer” or “polymeric”, as used interchangeably herein, may comprise homopolymers, copolymers, such as, for example, block, graft, random, and alternating copolymers, terpolymers, etc., and blends and modifications thereof Furthermore, unless otherwise specifically limited, the term “polymer” or “polymeric” shall include all possible structural isomers; stereoisomers including, without limitation, geometric isomers, optical isomers or enantionmers; and/or any chiral molecular configuration of such polymer or polymeric material. These configurations include, but are not limited to, isotactic, syndiotactic, and atactic configurations of such polymer or polymeric material.

The terms “nonwoven” and “nonwoven web”, as used herein, may comprise a web having a structure of individual fibers, filaments, and/or threads that are interlaid but not in an identifiable repeating manner as in a knitted or woven fabric. Nonwoven fabrics or webs, according to certain embodiments of the invention, may be formed by any process conventionally known in the art such as, for example, meltblowing processes, spunbonding processes, hydroentangling, air-laid, and bonded carded web processes.

The term “layer”, as used herein, may comprise a generally recognizable combination of similar material types and/or functions existing in the X-Y plane.

The term “spunbond”, as used herein, may comprise fibers which are formed by extruding molten thermoplastic material as filaments from a plurality of fine, usually circular, capillaries of a spinneret with the diameter of the extruded filaments then being rapidly reduced. According to an embodiment of the invention, spunbond fibers are generally not tacky when they are deposited onto a collecting surface and may be generally continuous. It is noted that the spunbond used in certain composites of the invention may include nonwoven described in the literature as SPINLACE®.

The term “meltblown”, as used herein, may comprise fibers formed by extruding a molten thermoplastic material through a plurality of fine die capillaries as molten threads or filaments into converging high velocity, usually hot, gas (e.g. air) streams which attenuate the filaments of molten thermoplastic material to reduce their diameter, which may be to microfiber diameter, according to certain embodiments of the invention. According to an embodiment of the invention, the die capillaries may be circular. Thereafter, the meltblown fibers are carried by the high velocity gas stream and are deposited on a collecting surface to form a web of randomly disbursed meltblown fibers. Meltblown fibers are microfibers which may be continuous or discontinuous and are generally tacky when deposited onto a collecting surface.

In accordance with certain embodiments of the invention, the inventors have conceived that shelters for trees, shrubs, vines, and the like may be constructed to be collapsible reducing the size of the structure to a streamlined form more conducive to the economies and/or efficiencies of shipping and transport. For example, shelters marketed under the name TUBEX® (by Fiberweb Geosynthetics Ltd., a company of Fiberweb, Inc., which is a company of AVINTIV Specialty Materials Inc. of Charlotte, N.C.) are mostly cylindrical in nature having a hollow inside space. Such shelters marketed under the name TUBEX®, however, are currently not designed to be collapsible.

According to certain embodiments of the invention, the shelters may be designed to be more of a conical shape allowing a plurality of shelters to be stacked one on top of the other to provide a reduction in overall volume for efficiency of shipping and transport. For instance, embodiments in accordance with certain embodiments of the invention comprise a generally conical shape. The conical shape of such embodiments of the invention enable the efficient stacking of a plurality of such shelters one on top of the other to provide a reduction in overall volume for shipping and transport per unit (e.g., shelter).

In accordance with certain embodiments of the invention, the shelter may be in the shape of a tube or cylinder and formed of a thermoplastic polymer that can be translucent. If light is only provided at the upper opening of the structure, for example, then the growth of the young plant may become hindered. Accordingly, a shelter comprising a translucent polymer may mitigate against hindrance of plant or tree growth by enable light to reach substantially all or all portions of the plant or tree enclosed and/covered by the shelter. In accordance with certain embodiments of the invention, the tube or cylinder shaped shelter may comprise a cross-sectional diameter (e.g., in an x-y plane) sufficient to encompass (e.g., encircle) the seedling (e.g., young plant or young tree) during the period of use and a length (e.g., along the z-axis) that typically is less than the seedling (e.g., young plant or young tree) at the time of planting but may be adapted to achieve a desired growth profile over time. In this regard, for example, the shelter may comprise a variable length (e.g., along the z-axis) including a first length that may be less than a length of the seedling (e.g., young plant or young tree) at the time of planting and increased in length over a period of time to at least a second length being greater than the first length. As noted above, the variable length of the shelter may enable a desired growth profile for the seedling (e.g., young plant or young tree) over a given period of time.

In accordance with certain embodiments of the invention, the inventors have further conceived that the shelter may remain in a substantially cylindrical format but to be designed to be collapsible. According to an embodiment of the invention, for example, the shelters may be configured to collapse in the longitudinal direction (e.g., along the length or z-axis of the shelter). According to another embodiment of the invention, the shelters may be configured to collapse in the axial direction.

According to an embodiment of the invention, the shelter may be defined by a longitudinal hollow sleeve configured to fit over the plant or tree and including a first end for insertion into the ground and a second end diametrically opposed to the first end. In certain embodiments of the invention, the longitudinal sleeve may be defined at least in part by a protective portion beginning at or proximate to the first end.

The protective portion, in some embodiments of the invention, may comprise another layer disposed either internal or external to the longitudinal hollow sleeve. In certain embodiments of the invention, the protection portion may comprise a film. In accordance with certain embodiments, the film may comprise, for example, compounds that assist with protecting the shelter from degradation due to contact with the soil and/or other environmental elements. In certain embodiments of the invention, the protective portion may comprise a coating, in which the coating includes, for example, compounds that assist with protecting the shelter from degradation due to contact with the soil and/or other environmental elements. In certain embodiments of the invention, the protection portion may comprise any combination of another layer, a film, and a coating, as described herein.

According to an embodiment of the invention, a collapsible tree shelter may comprise a longitudinal tubular structure having a first end for placing upon the ground and/or insertion into the ground. The longitudinal sleeve, in accordance with certain embodiments of the invention, may be configured to fit over the plant or tree. The longitudinal sleeve may also comprise a second end diametrically opposed to the first end. Further pursuant to such embodiments of the invention, for example, the collapsible tree structure may comprise one or more circumferential strengthening portions substantially surrounding the longitudinal tubular structure at the point where they are included. In an embodiment of the invention, the one or more longitudinal strengthening portions are configured to substantially define the body of the collapsible tree structure when in a collapsed state yet providing rigidity to the structure in an expanded state.

According to an embodiment of the invention, a collapsible tree shelter may comprise a longitudinal tubular structure having a first end for placing upon the ground and/or insertion into the ground. The longitudinal sleeve, in accordance with certain embodiments of the invention, may be configured to fit over the plant or tree. The longitudinal sleeve may also comprise a second end diametrically opposed to the first end. Further pursuant to this embodiment of the invention, the collapsible tree structure may comprise one or more longitudinal strengthening portions substantially extending along the length of the longitudinal tubular structure.

In an embodiment of the invention, a collapsible shelter comprises a fold line located at one side of the structure wherein the fold line longitudinally bisects a side of the longitudinal tubular structure allowing the structure to be folded into a substantially flat configuration at the fold. Upon extending the parts of the longitudinal tubular structure defined by the fold line, the body of the structure is configured to forcefully roll into a tubular form to define the longitudinal tubular structure that becomes placed or fitted over the plant or tree.

FIG. 1A illustrates an isometric view of a collapsed shelter according to an embodiment of the invention. The shelter 1 illustrated in FIG. 1A is defined by a longitudinal structure 10 having a first end 20 and a diametrically opposed second end 30. FIG. 1A shows a first longitudinal compression side 40 and a second longitudinal compression side 42, both running substantially continuously along the longitudinal direction of the longitudinal structure 10 from the first end 20 to the second end 30. The shelter 1 illustrated in FIG. 1A is configured to collapse at the first longitudinal compression side 40 and the second longitudinal compression side 42. For example, the materials of construction of the shelter 1, the amount of material extruded within the vicinity of the first longitudinal compression side 40 and the second longitudinal compression side 42, and/or the grain direction of the material of the longitudinal structure 10 may be such that the shelter 1 collapses at the first longitudinal compression side 40 and the second longitudinal compression side 42 to form a collapsed shelter 1 illustrated in FIG. 1A. Put another way, the first longitudinal compression side 40 and the second longitudinal compression side 42 are each configured to flexibly pivot inwardly allowing one side (e.g., a first side) of the longitudinal structure 10 defined by the first longitudinal compression side 40, the second longitudinal compression side 42, the first end 20 and the second end 30 to become substantially parallel to an opposite side (e.g., a second side) opposed to the one side (e.g., the first side) of the longitudinal structure 10.

FIG. 1B is an isometric view of the shelter of FIG. 1A in an expanded, uncollapsed configuration according to an embodiment of the invention. The shelter 1 of FIG. 1B is substantially cylindrical in form. As shown in FIG. 1B, the first longitudinal compression side 40 and the second longitudinal compression side 42 shown in FIG. 1A substantially disappear when the shelter 1 is in its uncollapsed state. In certain embodiments of the invention, the first longitudinal compression side 40 and the second longitudinal compression side 42 may be defined by a stretchable region that allows the first longitudinal compression side 40 and the second longitudinal compression side 42 to flexibly pivot radially along their axis. In this regard, the stretchable region(s) may comprise a latent ability to stretch greater than remainder of the shelter.

The longitudinal tubular structure shown in FIGS. 1A and 1B is configured to lie substantially flat upon application of an axial force being applied to the longitudinal tubular structure, otherwise known as an uncollapsed and/or uncrimped form. An opposite force applied to both sides of the tubular circular will cause the tubular structure to curl or axially open to form the tubular body of the longitudinal tubular structure. In accordance with certain embodiments of the invention, each end of the longitudinal tubular structure 20, 30 will allow the longitudinal tubular structure to be compressed into the collapsed or crimped state. The longitudinal tubular structure once collapsed into the collapsed or crimped state comprises a structure comprising (i) a first side of the longitudinal structure defined by a first compression side extending longitudinally from a first end to a second end of the longitudinal structure, (ii) a second compression side extending longitudinally from the first end to the second end of the longitudinal structure and being located diametrically opposed to the first compression side, (iii) the first end, (iv) the second end, and (v) the first side and a second side, which is opposed to the first side, being substantially parallel to each other. The collapsed or crimped state may be achieved upon compressing the first side and the second side.

In an embodiment of the invention, at least one of the first longitudinal compression side 40 and the second longitudinal compression side 42 is opened and configured to overlap over part of the body of the longitudinal structure 10 in the uncollapsed or uncrimped state. Without intending to be bound by theory, the overlapped portion along the body of the longitudinal structure 10 provides structural support along the longitudinal direction of the shelter 1. In certain embodiments of the invention, one or more circumferential strengthening portions substantially surrounding the longitudinal tubular structure either along the inside of the longitudinal tubular structure or along the outside of the longitudinal structure may be included to provide stability to the structure in the uncollapsed or uncrimped state.

In certain embodiments of the invention, while the shelter provides a relatively strong structure to resist the weather related elements to which it will be exposed when placed outside, the structure may be again collapsed for reuse and/or transport away from the site of use. In this regard, for example, the longitudinal tubular structure may be configured to lie flat upon application of an axial force being applied to the longitudinal tubular structure even after the shelter has been used.

A shelter according to certain embodiments of the invention can be conveniently packaged, stored, or transported in a substantially flat configuration enabling a large number of shelters to be placed in a small space. Due to the longitudinal tubular structure preferentially remaining in the formed tubular shape upon a force being applied to the ends, the structure remains relatively resilient allowing the structure to withstand natural elements once the shelter has been positioned to surround the plant or tree.

According to certain embodiments of the invention, the ends of the longitudinal tubular section may be configured to become more permanently affixed to one another. For example, a pressure sensitive adhesive may be applied such that the overlapping ends remain more securely affixed to one another. According to another embodiment of the invention, a mechanical closure device or means may be used to affix the two ends of the overlapping longitudinal tubular structure. According to yet another embodiment of the invention, hook and loop fasteners may be used to more securely affix the overlapping ends of the longitudinal tubular section. In an embodiment of the invention, one or both ends of the longitudinal tubular section are configured to have an affixing strip to allow the overlapping ends to remain more securely affixed to one another.

In certain embodiments of the invention, the shelter according to the present invention may be reversibly converted from a formed configuration back to a flat sheet upon application of a force. In another embodiment of the invention, once in its formed configuration, the circumferential strengthening members may be collapsed to allow the longitudinal tubular section to return to its flattened or uncrimped state. A shelter configured with this feature may therefore be reusable or repositionable to accommodate the needs of a growing plant or tree.

The longitudinal tubular structure may be manufactured in a variety of sizes (both length and diameter) to accommodate many different sizes, for example, of trees, shrubs or vines.

FIG. 1C is a cross-sectional view of a collapsed shelter according to another embodiment of the invention. In such embodiments of the invention illustrated by FIG. 1C, the collapsed shelter may comprise an arcuate or semi-circular shape. The shelter 2 of FIG. 1C comprises a longitudinal tubular structure 50 and is defined by a first longitudinal compression side 60 and a second longitudinal compression side 62. One side of the longitudinal tubular structure 50 defined between the first longitudinal compression side 60 and the second longitudinal compression side 62 is configured to bow and flexibly reshape itself to become substantially aligned with the other side defined between the first longitudinal compression side 60 and the second longitudinal compression side 62. For example, the side that becomes bowed to realign itself (e.g., a first side) with the opposite, unbowed side (e.g., a second side), may become reshaped upon application of a force substantially centrally to this side (e.g., the first side) defined between the first longitudinal compression side 60 and the second longitudinal compression side 62. While a shelter that collapses to the configuration in FIG. 1C may similarly collapse to the shape shown in FIG. 1A upon, for example, application of an axial force being applied to the longitudinal tubular structure, the shelter may be further collapsed such that each of the sides defined between the first longitudinal compression side 60 and the second longitudinal compression side 62 become substantially aligned for further economy and efficiency of shape for shipping and transport.

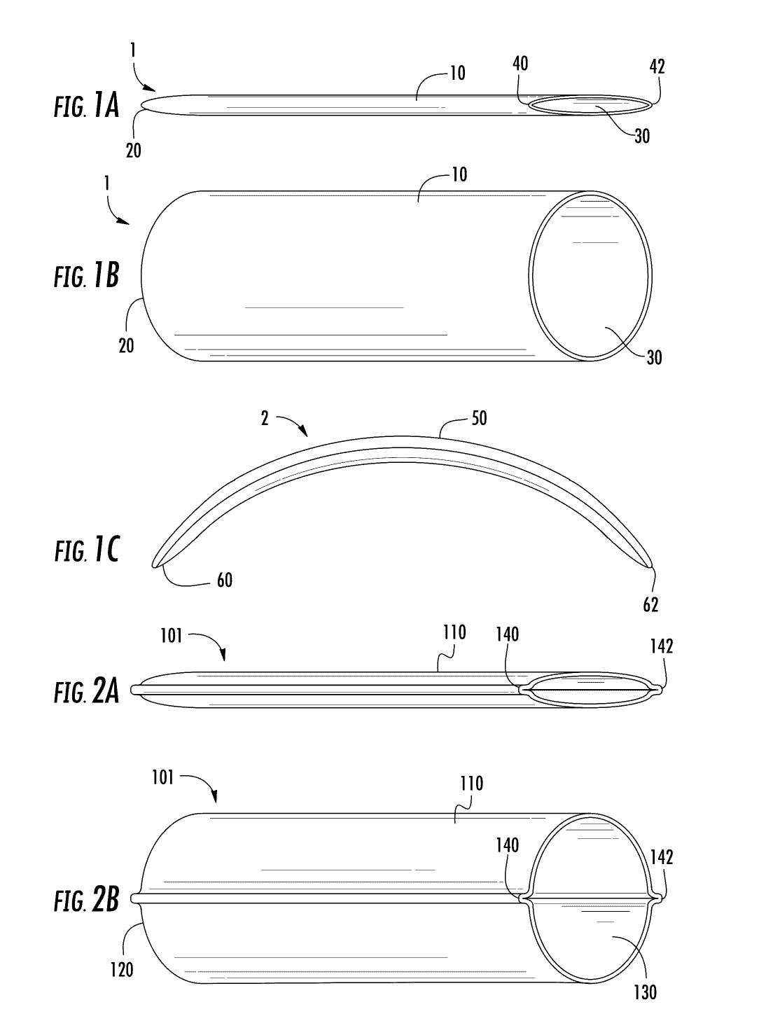

FIG. 2A illustrates an isometric view of a collapsed shelter according to another embodiment of the invention. FIG. 2B is an isometric view of the shelter of FIG. 2A in an expanded, uncollapsed configuration according to another embodiment of the invention. The shelter 101 of FIG. 2A, in a collapsed form, comprises a longitudinal tubular structure 110 having a first end 120 and a diametrically opposed second end 130. While the shelter 101 of FIGS. 2A and 2B may be configured to be substantially the same as already described herein for shelter 1 of FIGS. 1A, 1B and 1C, shelter 101 additionally comprises a first longitudinal compression line 140 and a second longitudinal compression line 142 diametrically opposed to the first longitudinal compression line 140. The first longitudinal compression line 140 and the second longitudinal compression line 142 are substantially continuous along the longitudinal tubular structure 110 extending from first end 120 to second end 130.

The first longitudinal compression line 140 and the second longitudinal compression line 142 may be configured to flexibly pivot inwardly allowing a first side of the longitudinal tubular structure 110 defined by (i) the first longitudinal compression line 140, (ii) the second longitudinal compression line 142, (iii) the first end 120, and (iii) the second end 130 to become substantially parallel with a second side of the longitudinal tubular structure 110 that is opposed to the first side.

According to an embodiment of the invention, the first longitudinal compression line 140 and the second longitudinal compression line 142 may each be defined by a crease that runs along the longitudinal tubular structure 110. According to another embodiment of the invention, the first longitudinal compression line 140 and the second longitudinal compression line 142 may be fluted lines within the body of the longitudinal tubular structure 110. According to yet another embodiment of the invention, dimpled structures may extend along the first longitudinal compression line 140 and the second longitudinal compression line 142 in the body of the longitudinal tubular structure 110.

In yet other embodiments of the invention, the first longitudinal compression line 140 and the second longitudinal compression line 142 may be a hinged structure capable of being flexed and unflexed to allow the shelter 101 to become collapsed and uncollapsed. The hinged structures define the first longitudinal compression line 140 and the second longitudinal compression line 142 in the example embodiments of FIGS. 2A and 2B. Similar to the embodiment illustrated in FIG. 1C, the shelter 101 may additionally be configured to further collapse where the sides defined between first longitudinal compression line 140 and the second longitudinal compression line 142 become more substantially aligned similar to the cross-section shown in FIG. 1C, but having the longitudinal compression lines defined for the embodiment exemplified in FIGS. 2A and 2B.

In yet other embodiments of the invention, the first longitudinal compression line 140 and the second longitudinal compression line 142 may be a combination of any of the structures defined herein—i.e., any combination defined by a crease, flutes, dimples, hinge or any other structure capable of becoming flexibly pivoted inwardly contemplated by a person of ordinary skill in the art having the benefit of this disclosure to allow the longitudinal tubular structure to be compressed into the collapsed or crimped state with a first side of the longitudinal structure defined by a first compression side extending longitudinally from a first end to a second end of the longitudinal structure, a second compression side extending longitudinally from the first end to the second end of the longitudinal structure and diametrically opposed to the first compression side, the first end and the second end, the first side and a second side opposed to the first side to become substantially parallel upon compressing the first side and the second side.

In an embodiment of the invention, a ground support ring near the opening of the shelter configured to rest on or to be inserted into the ground may surround a base of the shelter. The ground support ring may be configured to be, for example, a strengthening member, a portion that reduces rapid degradation due to being in contact with a ground, a member that is configured to allow the shelter to be inserted in the ground, as well as other uses as contemplated by a person of ordinary skill in the art having the benefit of this disclosure.

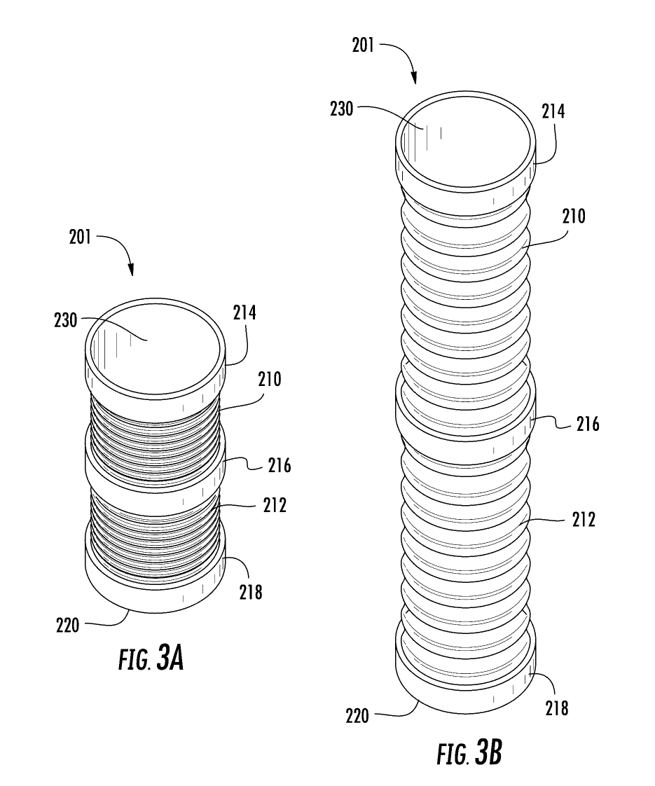

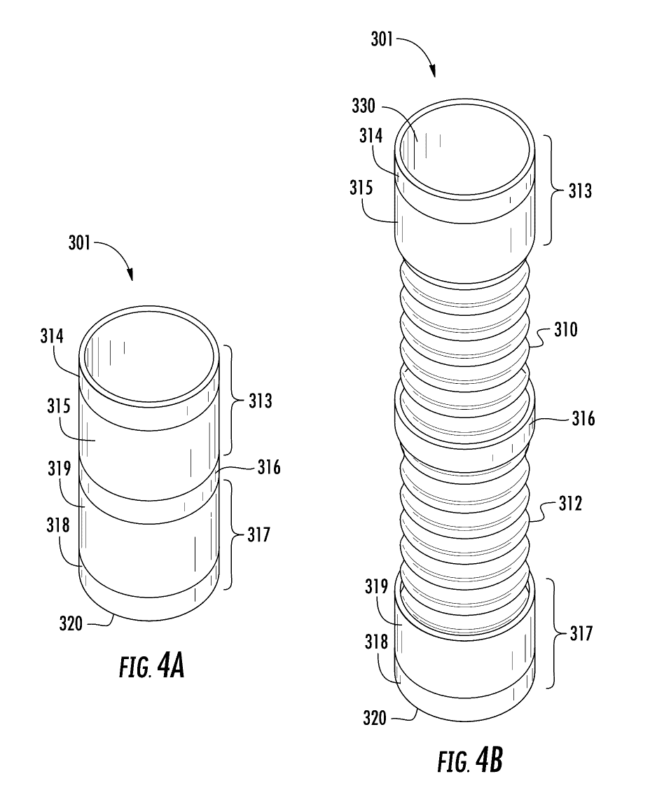

Yet other example embodiments of the inventive collapsible tree structures are provided. FIG. 3A is an isometric view of a collapsed shelter according to another embodiment of the invention, while FIG. 3B is an isometric view of the shelter of FIG. 3A in an expanded, uncollapsed configuration further pursuant to this embodiment of the invention. The shelter 201 of FIGS. 3A and 3B is cylindrical in form, i.e., a longitudinal tubular structure, having a first end 220 and a diametrically opposed second end 230. The longitudinal tubular structure, according to this embodiment, is defined by a first longitudinal tubular structure 210 and a second longitudinal tubular structure 212 further having a first support ring 214 at the second end 230, a second support ring 216 positioned between the first longitudinal tubular structure 210 and the second longitudinal tubular structure 212, and a third support ring 218 at the first end 220.

The bodies of the first longitudinal tubular structure 210 and the second longitudinal tubular structure 212 are configured to collapse (e.g., independently collapse) in the longitudinal direction. For example, as illustrated in FIGS. 3A and 3B, the bodies of the first longitudinal tubular structure 210 and the second longitudinal tubular structure 212 may be circumferentially fluted allowing the shelter 201 to become collapsed as illustrated in FIG. 3A upon application of a compressive force applied, for example, between the first end 220 and the second end 230. According to this embodiment, the length of the structure may be varied as desired or over time, for example, to correspond to the growth of a growing plant or tree. In accordance with certain embodiments of the invention, a preferred or desired position of the first longitudinal tubular structure 210 and the second longitudinal tubular structure 212 may be in the expanded or uncollapsed position.

According to certain other embodiments of the invention, the desired or preferred position of the first longitudinal tubular structure 210 and the second longitudinal tubular structure 212 may be in the collapsed state (e.g., the first longitudinal tubular structure 210 and the second longitudinal tubular structure 212 lacking application of an opposing force, may be in the collapsed state). Further pursuant to this embodiment, a force may be applied to expand the first longitudinal tubular structure 210 and the second longitudinal tubular structure 212 to the uncollapsed state. Further pursuant to these embodiments, additional one or more support members may be provided to allow the shelter 201 to remain in the collapsed position according to one embodiment of the invention and in the uncollapsed position according to another embodiment of the invention. In yet another embodiment of the invention, one or more support members are provided to allow the shelter 201 to remain in the collapsed position and in the uncollapsed position.

The shelter 201 of FIGS. 3A and 3B is an example representation of a shelter according to certain embodiments of the invention showing two longitudinal tubular structures and three support rings. An embodiment of the invention comprises a plurality of longitudinal tubular structures each capable of being collapsed between support rings, which number the total number of plurality of longitudinal structures plus one.

In yet another embodiment of the invention, the shelter comprises one longitudinal tubular structure configured to function in all respects to the first longitudinal tubular structure 210 and the second longitudinal tubular structure 212 of FIGS. 3A and 3B. Further pursuant to this embodiment of the invention, the one longitudinal tubular structure may be disposed between a first support ring at one end of the one longitudinal tubular structure and a diametrically opposed second support ring at the other end of the one longitudinal tubular structure.

In yet other embodiments of the invention, any of the support rings near one of the openings of the shelter may be configured to be a ground support ring. The configuration and benefits of the ground support ring are further disclosed herein.

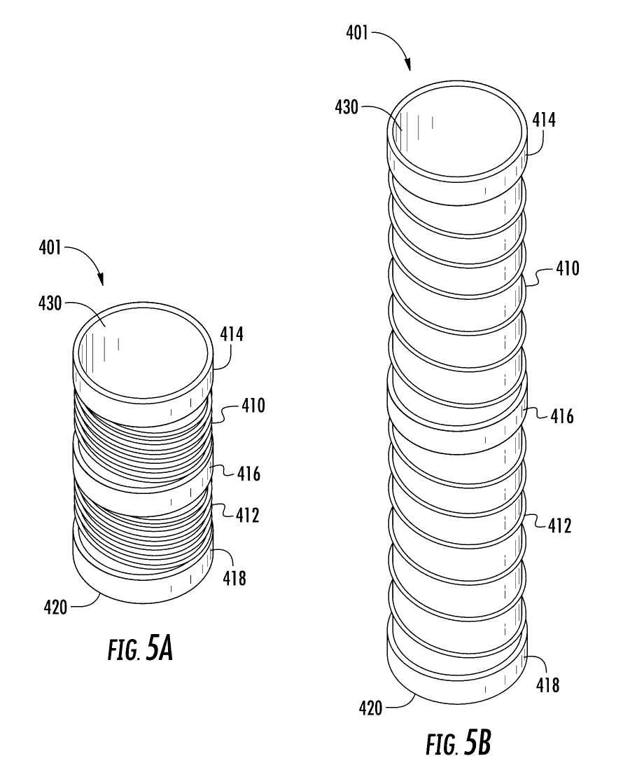

FIG. 4A is an isometric view of a collapsed shelter according to another embodiment of the invention, while FIG. 4B is an isometric view of this shelter of FIG. 4A in an expanded configuration. A shelter 301 of FIGS. 4A and 4B is a variation on the shelter 201 of FIGS. 3A and 3B. Similar to shelter 201, shelter 301 is defined by a longitudinal tubular structure, having a first end 320 and a diametrically opposed second end 330. The longitudinal tubular structure, according to this embodiment, is defined by a first longitudinal tubular structure 310 and a second longitudinal tubular structure 312 further having a first ring 313 at the second end 330, a second support ring 316 positioned between the first longitudinal tubular structure 310 and a second longitudinal tubular structure 312, and a third ring 317 at the first end 320. However, the first support ring 313 further comprises a support member of the first ring 314 and a cover member of the first ring 315, while the third ring 317 further comprises a support member of the third ring 318 and a cover member of the third ring 319.

The support member of the first ring 314 and the support member of third ring 319 of shelter 301 may be configured to perform the same support function as the first support ring 214 and third support ring 218 for shelter 201. But shelter 301 also comprises the cover member of the first ring 315, which is configured to cover the first longitudinal tubular structure 310 when it is collapsed, while the cover member of the third ring 319 is configured to cover the second longitudinal tubular structure 312 when it is collapsed. Thus, a body of the collapsed shelter 301, as shown in FIG. 4A, may be defined by the first ring 313, the second ring 316, and the third ring 317 with the collapsed longitudinal tubular structure 310 and the second collapsed longitudinal tubular structure 312 hidden and protected by the first ring 313, the second ring 316, and the third ring 317.

Similar to shelter 201, shelter 301 may have only one longitudinal tubular structure or a plurality of longitudinal structures defined by rings that comprise, as needed, cover members so that the collapsed longitudinal support or collapsed longitudinal supports are hidden and protected by the rings, in particular, the cover member of the rings.

FIG. 5A is an isometric view of a collapsed shelter according to another embodiment of the invention, while FIG. 5B is an isometric view of the shelter of FIG. 5A in an expanded configuration further pursuant to this embodiment of the invention. The shelter 401 of FIGS. 5A and 5B may be defined by a first end 420 and a diametrically opposed second end 430. The shelter 401, according to this embodiment, further comprises a first longitudinal tubular structure 410 and a second longitudinal tubular structure 412 further having a first support ring 414 at the second end 430, a second support ring 416 positioned between the first longitudinal tubular structure 410 and the second longitudinal tubular structure 412, and a third support ring 418 at the first end 420. In certain embodiments of the invention, at least one or both of the first longitudinal tubular structure 410 and the second longitudinal tubular structure 412 comprise a spring member either positioned external to the longitudinal structure or internal to such structure.

In this regard, for example, the shelters illustrated by FIGS. 3A-5B comprise a variable length (e.g., along the z-axis) including, for example, a first length that may be less than a length of a seedling (e.g., young plant or young tree) at a first point in time (e.g., time of planting) and increased in length over a period of time to at least a second length being greater than the first length. As noted above, the variable length of the shelter may be correlated to a desired growth profile for the seedling (e.g., young plant or young tree) over a given period of time.

The spring may be configured to spiral along an exterior surface of the longitudinal tubular structure, according to an embodiment of the invention. In certain embodiments of the invention, the spring may be configured to spiral along an interior side of the longitudinal tubular structure. In still certain other embodiments of the invention, the spring may be configured to spiral internal to a body of the longitudinal tubular structure.

The spring may be metallic or constructed of a formed plastic, for example, either intrinsic with the body of the longitudinal structure or as a separate component of such structure. The spring may be configured to require a compressive force to collapse the longitudinal structure or configured to require a force to expand the longitudinal structure to the uncollapsed position. According to one embodiment of the invention, the spring comprises a compression spring that requires a compressive force to collapse the longitudinal tubular structure. In another embodiment of the invention, the spring comprises a tension spring that requires a force to extend the longitudinal tubular structure.

Similar to shelter 201 and shelter 301, shelter 401 may have only one longitudinal tubular structure or a plurality of longitudinal structures. Similar to shelter 301, shelter 401 may be configured to have covers to hide and/or protect the longitudinal support structure(s) when in the collapsed position.

An aspect of the invention provides a method for manufacturing a collapsible shelter comprising the steps of forming a longitudinal tubular structure defined by a first end and a diametrically opposed second end also having a first longitudinal compression line and an oppositely configured second longitudinal compression line. Alternatively, the first longitudinal compression line and oppositely configured second longitudinal compression line may be formed into the longitudinal tubular structure in certain embodiments of the invention.

According to another embodiment of the invention, a method for manufacturing a collapsible shelter includes the steps of forming one or more longitudinal tubular structures, whereby such structures are fluted and/or include a spring member to allow the longitudinal tubular structures to be collapsed; and providing rings to define the openings of the longitudinal tubular structure or interconnect the more than one longitudinal tubular structure. According to certain embodiments of the invention, the rings may be further configured to cover the one or more longitudinal support members when in the collapsed position.

In accordance with certain embodiments of the invention, for instance, the shelter of the invention may be constructed of a polymer, for example, either an extruded thermoplastic or thermoset polymer or a mold-formed thermoplastic or thermoset polymer. According to certain embodiments, for instance, the polymers may comprise at least one of polyethylene, polypropylene, partially aromatic or fully aromatic polyesters, polyhexamethylene diadipamide, polycaprolactam, aromatic or partially aromatic polyamides, aliphatic polyamides, or any combination thereof In some embodiments, for example, the polymer may comprise polypropylene.

The material of the shelter may additionally comprise one or more additives and/or fillers. In a non-limiting example, fillers to increase the useful lifetime of the material and/or enhance the properties of the shelter may be incorporated into one or more portions of the material forming the shelter. Such additives may include, but are not necessarily limited to, UV stabilizers, waterproofing additives, extending fillers, and prodegradant agents that control the degradation caused by oxygen in the atmosphere. Examples of extending fillers include wood flour, olive stones powder, wheat straw flour, rice hull ash, and other extending fillers know in the art.

The material of the shelter may additionally comprise reinforcing fillers, for example, to reinforce, the shelter or some portion of the shelter such as any one or more of the longitudinal tubular structure, support ring, ground protection ring, and any other part of the shelter. Other fillers that may be used to control the amount of light and/or the wavelength of light that may pass through the shelter. In an embodiment of the invention, a calcium carbonate filler, preferably a coated calcium carbonate filler having an average particle size of less than about 3 microns is used as a filler to, for at least one of, control the amount and/or wavelength of light that may pass through the shelter.

In certain embodiments of the invention, the shelter may comprise a material that is biodegradable. Examples of biodegradable materials include polylactic acid (PLA), polyhydroxy butyrate (PHB), poly-hydroxybutyrate-co-b-hydroxy valerate (PHBV), polyglycolic acid (PGA), polycaprolactone (PCL), and any combination thereof A non-limiting example of a commercially available biopolymer is marketed under the name MATER-BI® by Novamont, an Italian chemical company. In certain embodiments of the invention, only a portion of the shelter includes a biodegradable material, for example, allowing that portion of the shelter to biodegrade over time.

According to an embodiment of the invention, the shelter may comprise an extruded plastic component, for example, any one or more of the longitudinal tubular structure and or one or more of the rings. In other embodiments of the invention, the shelter may comprise a nonwoven. In yet other embodiments of the invention, the shelter may comprise a nonwoven composite. In a non-limiting example of a shelter that comprises a nonwoven composite, the nonwoven composite comprises at least one nonwoven layer and a film. The film may be an extruded film according to certain embodiments of the invention. In certain embodiments of the invention, the nonwoven composite may comprise a meltblown layer a spunbond layer or both. In yet certain embodiments of the invention, the nonwoven composite may comprise a film or a film laminate layer that may be configured to be a monolithic film structure. In yet even other embodiments of the invention, the film or film laminate of the nonwoven composite may be a microporous film structure. In accordance with certain embodiments of the invention, the nonwoven composite may be positioned around and permanently or removably attached to the shelter, such as around an outer or inner circumference of at least a portion of the shelter. In this regard, the shelter may optionally comprise one or more through-holes (e.g., apertures) through the body of the shelter and the nonwoven composite (or simply a single nonwoven layer) may overlay or cover the through-holes to provide protection against external wind to mitigate wind damage for the plant or tree.

These and other modifications and variations to the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A shelter comprising:
(a) a longitudinal tubular structure having a first end and a second end, the second end being diametrically opposed to the first end;
(b) a first compression side extending longitudinally from the first end to the second end;
(c) a second compression side diametrically opposed to the first compression side;
(d) a first side of the longitudinal structure defined by the first compression side, the second compression side, the first end, and the second end; and
(e) a second side of the longitudinal structure opposed to the first side,
wherein the first compression side and the second compression side are configured to flexibly pivot inwardly from an uncollapsed configuration and to allow the first side to become substantially parallel to the second side to form a collapsed configuration.

2. The shelter according to claim 1, wherein when shelter is in the collapsed configuration, the second side is configured to bow flexibly inward to allow the second side to become substantially aligned with the first side.

3. The shelter according to claim 1, wherein at least one of the first compression side and the second compression side comprises a stretchable region.

4. The shelter according to claim 1, wherein at least one of the first compression side and the second compression side comprises a crease extending from the first end to second end in a body of the longitudinal tubular structure.

5. The shelter according to claim 1, wherein at least one of the first compression side and the second compression side comprises a fluted structure extending from the first end to the second end in a body of the longitudinal tubular structure.

6. The shelter according to claim 1, wherein at least one of the first compression side and the second compression side comprises a dimpled structure extending from the first end to second end in a body of the longitudinal tubular structure.

7. The shelter according to claim 1, wherein at least one of the first compression side and the second compression side comprises a hinged structure extending from the first end to second end in a body of the longitudinal tubular structure.

8. A shelter comprising:
(a) a first longitudinal tubular structure having a first end and a second end, the second end being diametrically opposed to the first end;
(b) a first support ring circumferentially surrounding the longitudinal tubular structure at the first end; and
(c) a second support ring circumferentially surrounding the longitudinal tubular structure at the second end,
wherein the longitudinal tubular structure is configured to collapse in the longitudinal direction upon application of an external force.

9. The shelter according to claim 8, wherein the first support ring further comprises a cover member configured to substantially surround the first longitudinal tubular structure when the first longitudinal tubular structure is collapsed into a substantially complete collapsed state.

10. The shelter according to claim 8, wherein the first longitudinal tubular structure comprises fluting.

11. The shelter according to claim 8, the first longitudinal tubular structure further comprises a spring.

12. The shelter according to claim 11, wherein the spring spirally surrounds an external surface of the first longitudinal tubular structure.

13. The shelter according to claim 11, wherein the spring spirals and is surrounded by an internal surface of the first longitudinal tubular structure.

14. The shelter according to claim 11, wherein the spring is disposed internal to the first longitudinal tubular structure.

15. The shelter according to claim 11, wherein the spring comprises a compression spring.

16. The shelter according to claim 11, wherein the spring comprises a tension spring.

17. The shelter according to claim 8, further comprising:
(d) a second longitudinal structure having a third end and a fourth end, the fourth end being diametrically opposed to the third end; and
(e) a third support ring circumferentially surrounding the second longitudinally support structure at the fourth end,
wherein the third end is joined to the second end, and the third end and fourth end share the second support ring; the second longitudinal tubular structure being configured to collapse in the longitudinal direction upon application of an external force.

18. A method of manufacturing a collapsible shelter comprising:
forming one or more longitudinal tubular structures each defined by a first end and a diametrically opposed second end;
affixing a first support ring radially surrounding a first longitudinal tubular structure of the one or more longitudinal structures at the first end; and
affixing a second support ring radially surrounding the first longitudinal tubular structure at the second end;
wherein the first longitudinal tubular structure is configured to collapse in a longitudinal direction.

19. The method of claim 18, further comprising:
interconnecting the first longitudinal tubular structure to a second longitudinal tubular structure via the second support ring.

20. The method of claim 18, further comprising a step of disposing a spring about a portion of an external surface of at least the first longitudinal tubular structure.
